(19) United States
(12) Patent Application Publication
(10) Pub. No.: US 2008/0242383 A1
(43) Pub. Date: Oct. 2, 2008

(54) FIRE RETARDANT COVER FOR RADIO ACCESSORIES

(76) Inventors: John A. Towns, St. Charles, IL (US); Willow Curtin, Crystal Lake, IL (US)

Correspondence Address: MCANDREWS HELD & MALLOY, LTD, 500 WEST MADISON STREET, SUITE 3400, CHICAGO, IL, 60661, US

(21) Appl. No.: 11/692,011

(22) Filed: Mar. 27, 2007

(51) Int. Cl. H04M 1/04

(52) U.S. Cl. 455/575.8

(57) ABSTRACT

A protective cover assembly is provided for a communications device of the type comprising a radio unit interconnected with an accessory either through a power cord or wireless technology. The cover assembly includes first and second portions constructed of a fire retardant material, such as NOMEX®. The first portion is configured to contain the accessory and the second portion is configured to contain the power cord. The first and second portions are releasably secured to one another by mechanical fasteners, such as snaps. The first portion includes a panel that can be opened to allow the cover to be slid over the radio accessory and closed to secure the cover over the accessory. Typically, the accessory is a speaker/microphone, in which case the cover first portion includes a perforated section that allows sound to pass through the cover.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Two-way radios, such as push-to-talk (PTT) radios, are commonly used to provide communications among emergency personnel such as fire fighters. In such applications, it is critical that the communications device remain operable in extreme conditions such as high temperature and moisture. Typically, such radios are used with a speaker/microphone that is interconnected with the radio through an extension cord. The radio is worn at or near the user's waist and the speaker/microphone is positioned near the user's chest or shoulder, so as to be in close proximity to the user's head. The radio is protected from the elements by the protective coat, referred to as a turn-out coat, that is worn by the fire fighter. However, in order to allow the user to hear and be heard, the speaker microphone is typically worn external to the turn-out coat. In this location, both the speaker/microphone and the power cord are exposed to extremes in temperature and moisture. Prior attempts to address these issues have failed because the materials used to construct the speaker/microphone have not been able to withstand the extreme temperatures and/or the manufacture of such accessories has been too proven to be too expensive to be commercially acceptable.

### SUMMARY OF THE INVENTION

A protective cover assembly is provided for a communications device of the type comprising a radio unit interconnected with an accessory through a power cord. The cover assembly includes first and second portions constructed of a fire retardant material. The first portion is configured to contain the accessory and the second portion is configured to contain the power cord. The first and second portions are releasably secured to one another by mechanical fasteners, such as snaps. The first portion includes a panel that can be opened to allow the cover to be slid over the radio accessory and closed to secure the cover over the accessory. Typically, the accessory is a speaker/microphone, in which case the cover first portion includes a perforated section that allows sound to pass through the cover.

According to another aspect of the present invention, a protective cover is provided for an accessory, such as speaker/microphone unit, of the type that is interconnected with a radio unit either through a power cord or wireless technology. The protective cover comprises a housing configured to enclose the accessory unit. The cover is formed of a fire retardant material and includes a sealable opening that is openable to allow the cover to be positioned over the speaker/microphone unit and that can be closed to secure the cover over the speaker/microphone unit. The sealable opening may comprise a flap that is movable between an open position to allow the cover to be positioned over the accessory unit and that a closed position to secure the cover over the accessory unit.

### BRIEF DESCRIPTION OF SEVERAL VIEWS OF THE DRAWINGS

FIG. 1 is a front perspective view of a fire retardant cover for a speaker/microphone according to certain aspects of the present invention.

FIG. 2 is a rear perspective view of the fire retardant cover of FIG. 1.

FIG. 3 is a front perspective view of the fire retardant cover of FIG. 1, further illustrating certain features of the cover.

FIG. 4 is a plan view of a fire-retardant power cord cover according to certain aspects of the present invention.

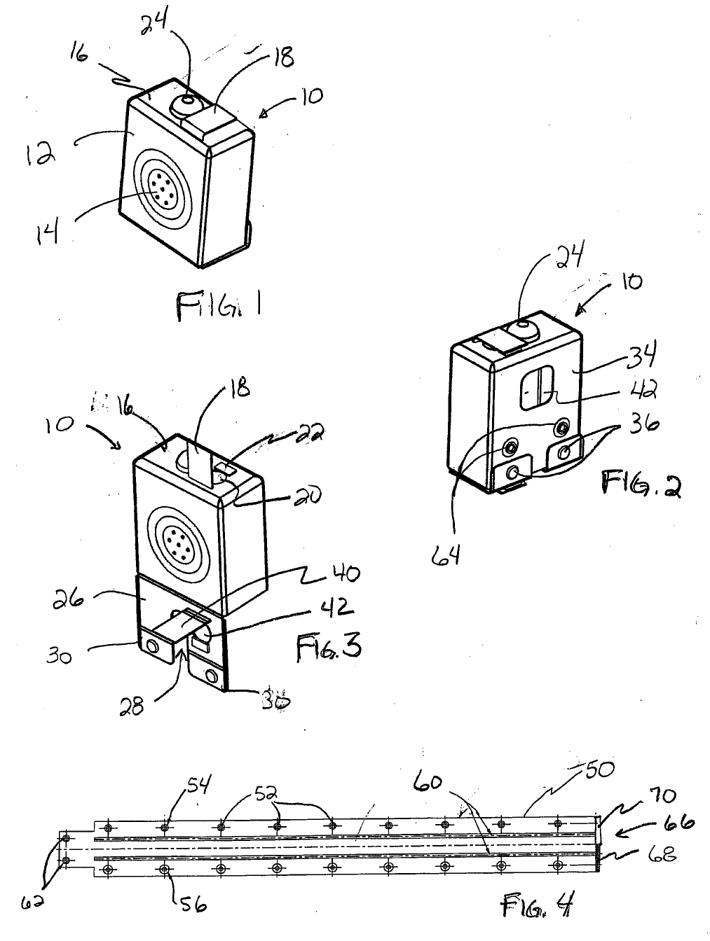

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

Referring to the drawings, a fire retardant cover 10 is configured for mounting over a radio accessory (not shown) of a two-way radio device (not shown). Examples of such devices can be found in U.S. Pat. Nos. 6,179,666; 6,026,282 and 5,038,400, the disclosures of which are hereby incorporated by reference. Typically the radio accessory comprises a speaker/microphone unit (not shown) which is interconnected with the radio unit through a power cord (not shown). Alternatively, the accessory unit may be interconnected with the radio unit through a wireless connection, such as a BlueTooth® connection.

The cover 10 is constructed from a fire retardant material, such as NOMEX®, as sold by DuPont, or other similar fire retardant materials. As will be appreciated, the specific design of the cover will be largely dictated by the specifics of the particular accessory with which the cover is intended to be used. In the illustrated embodiment, the cover 10 is configured for use with a speaker/microphone unit. The cover 10 is generally box shaped and includes a front panel 12 that overlies the front panel of the speaker/microphone unit. The front panel 12 includes a perforated section 14 that allows sound to pass through the cover 10 to allow the user to hear and be heard through the speaker/microphone unit. The top panel 16 includes a flap 18 that can be opened to allow the antenna of the speaker/microphone to pass through an opening 20 in the top panel. When not in use, the flap 18 is releasably held in its closed position by a hook and loop fastener, such as VELCRO® brand fastener. For example, the hook portion (not shown) can be carried by the inner surface of the flap 18 and the loop portion 22 can be positioned on the outer surface of the top panel.

In the illustrated embodiment, the top panel 16 includes a circular protuberance 24 that overlies the PTT button of the speaker microphone. The protuberance 24 acts as a visual and/or tactile locator for the underlying PTT button.

As can be seen in FIG. 3, the bottom panel 26 of the cover 10 opens to allow the cover to slide over the speaker/microphone. The bottom panel 26 includes a central opening or slot 28 to allow the power cord to pass through the cover. The bottom panel 26 includes tabs 30 that releasable secure the bottom panel in its closed position. Specifically, the tabs 30 and back panel 34 include mating fasteners for securing the bottom panel 26 in its closed position (See FIG. 2). In the illustrated embodiment, the fasteners 36 are snap-type fasteners, however, other connectors may be employed, such as loop and hook fasteners.

The bottom panel 26 includes a flap 40 that can be opened to allow the jack from an earphone to pass through an opening 42 in the bottom panel for connection to the speaker/microphone. When not in use, the flap 40 is releasably held in its closed position by a hook and loop fastener in the manner described above. For example, the hook portion can be carried by the inner surface of the flap 40 and the loop portion can be positioned on the outer surface of the bottom panel 26.

Similarly, the back panel 34 includes a flap 42 that can be opened to allow the clip (not shown) the speaker/microphone to pass through an opening in the back panel. When not in use, the flap 42 is releasably held in its closed position by a hook and loop fastener in the manner described above. For example, the hook portion can be carried by the inner surface of the flap 42 and the loop portion can be positioned on the outer surface of the back panel 34. As will be appreciated, the cover may include other features to accommodate the specifics of a given speaker/microphone unit.

FIG. 4 illustrates a power cord cover 50 according to certain aspects of the present invention. The cover 50 is configured to be wrapped around the power cord that interconnects the radio accessory to the radio unit. For this purpose, the cover 50 includes a plurality of fasteners 52 positioned along its length. In the illustrated embodiment, the fasteners are snap-type fasteners, however, other fasteners such as hook and loop fasteners may also be employed. The illustrated fasteners 52 comprise a row of button sockets 54 along one side of the cover 50 and a row or reciprocal studs 56 along the other side of the cover. In use, the cover 50 is laid on a flat surface as shown in FIG. 4 and the power cord is laid lengthwise on top of the cover. The cover 50 is then wrapped around the cord and the buttons and studs are snapped together to secure the cover 50 around the power cord. The cover 50 includes longitudinal elastic bands 60 to allow the cover to stretch around cords of varying diameters. One end of the power cord cover includes button sockets 62 that mate with reciprocal studs 64 on the back panel 34 of the speaker/microphone cover 10 to releasably secure the covers 10, 15 together. The other end of the cover includes a hook and loop fastener to further secure the cover 50 around the power cord. The hook fastener 68 is positioned on the inner surface of the cover 50 and the loop fastener 70 is positioned on the outer surface of the cover. When the cover 50 is wrapped around the cord, the hook and loop fasteners 68, 70 mate with one another to secure the end of the cover 50 around the cord.

The cover assembly of the present invention provides a highly effective thermal barrier for protecting communication equipment from the temperature extremes that fire fighters are exposed to during their work. The cover assembly uses a series of mechanical fasteners, such as snaps or loop and hook connectors, which make it easy to install and remove from the unit, e.g., for cleaning or replacement. The covers 10, 50 have been designed to allow the speaker/microphone and power cord to survive extreme temperature variations for short periods of time without failure of any functionality. The audio performance of the accessory is not significantly degraded by the application of the cover 10. Moreover, the cover 10 improves the grip and handling characteristics of the accessory due to the frictional properties of the material that is used to construct the cover.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A protective cover assembly for a communications device of the type comprising a radio unit interconnected with an accessory through a power cord, the cover assembly comprising:
a first portion configured to contain the accessory; and
a second portion configured to contain the power cord;
wherein the first and second portions are comprised of a fire retardant material.

2. The protective cover assembly of claim 1, wherein the first and second portions are releasably secured to one another.

3. The protective cover assembly of claim 1, wherein the first and second portions are releasably secured to one another by a snap-type connection.

4. The protective cover assembly of claim 1, wherein the first portion includes a panel that can be opened to allow the cover to be slid over the radio accessory.

5. The protective cover assembly of claim 1, wherein the accessory is a speaker/microphone and wherein the cover first portion includes a perforated section that allows sound to pass through the cover.

6. A protective cover for a speaker/microphone unit of the type that is interconnected with a radio unit either through a power cord or wireless technology, the protective cover comprising:
a housing configured to enclose the speaker/microphone unit, the cover being formed of a fire retardant material and including a flap that is movable between an open position to allow the cover to be positioned over the speaker/microphone unit and a closed position to secure the cover over the speaker/microphone unit.

7. The protective cover of claim 6, wherein the cover is generally box shaped.

8. The protective cover of claim 7, wherein the cover includes a front panel having a perforated portion that allows sound to pass through the cover without significantly degrading the fire-retardant properties of the cover.

9. The protective cover of claim 6, further comprising a second portion configured to contain a power cord that interconnects the speaker/microphone and the radio unit, the second portion being formed of a firer retardant material.

10. The protective cover of claim 9, wherein the housing and second portions are releasably secured to one another.

11. The protective cover assembly of claim 9, wherein the housing and second portion are releasably secured to one another by a snap-type connection.
